(19) United States
(12) Patent Application Publication
(10) Pub. No.: US 2004/0122146 A1
(43) Pub. Date: Jun. 24, 2004

(54) Coating composition using rubber compound, preferably scrap tire, and method of producing the same

(76) Inventors: Meyong Won Chun, Kyunggi-do (KR); Bong Ki Jang, Chungcheongnam-do (KR); Kwang Sceek Jeong, Kyunggi-do (KR)

Correspondence Address: PLUMSEA LAW GROUP, LLC, 10411 MOTOR CITY DRIVE, SUITE 320, BETHESDA, MD, 20817, US

(21) Appl. No.: 10/634,650

(22) Filed: Aug. 5, 2003

(30) Foreign Application Priority Data
Aug. 6, 2002 (KR) 2002-46353

(51) Int. Cl. C08J 3/00

(52) U.S. Cl. 524/356; 521/41; 524/379; 524/366; 524/433

(57) ABSTRACT

The present invention relates to a coating composition using rubber compound, preferably scrap tire, and method of producing the same. The coating composition is obtained by extracting a liquid styrene butadiene rubber (SBR) from a rubber compound, preferably scrap tire, containing carbon black, adding an additive for hardening the liquid SBR, and selectively adding another additives selected for the different usages of the composition. According to the present invention, a novel coating composition that can be used for rust proofing, waterproofing, fiber grid coating etc. is provided. Also, a large volume of rubber compounds, preferably scrap tires, which otherwise may cause environmental pollution, can be recycled in an economic and reliable process.

### BACKGROUND OF THE INVENTION

1. Field of the Invention

The present invention relates to a coating composition using rubber compound, preferably scrap tire, and method of producing the same. The coating composition is obtained by extracting a liquid styrene butadiene rubber (SBR) from a rubber compound, preferably scrap tire, containing carbon black, adding an additive for hardening the liquid SBR, and selectively adding another additives selected for the different usages of the composition.

2. Description of the Related Art

The coating composition is obtained by extracting a liquid styrene butadiene rubber (SBR) from a rubber compound, preferably scrap tire, containing carbon black, adding an additive for hardening the liquid SBR, and selectively adding another additives selected for the different usages of the composition.

Generally, scrap tires take up the largest portion of the high polymer wastes with the development of overland transportation, and the number of generated scrap tires is gradually increasing. Thus, an economic and reliable process is required for the environmentally beneficial disposal of the scrap tires.

It is currently estimated, in South Korea for example, that the number of cars was over 10 millions in 1997 and over 15 millions in 2001. The tire replacement rate is 1.3 pieces of tires per lifetime of a motorcar and 2.8 for a bus, and the mean is 1.9. It is estimated that the number of scrap tires generated in 2001 was 30 millions corresponding to 430 thousand tons in weight. Currently, only 28% of the scrap tires are recycled, and the remaining 72% are dumped in waste disposal sites or discarded without necessary treatment.

Technologies for processing scrap tires are classified into reclamation, the production of regenerated tire, incineration, the production of regenerated rubber and pyrolysis.

In case of the direct reclamation, it induces the second environmental pollution, because the scrap tire does not decompose under the ground.

The applicability of regenerated tire is usually limited to large-sized vehicles like bus and truck. The economic efficiency of tire-regeneration has been decreased because of the increasing replacement of tires into steel radial tires.

Incineration requires careful preparation because when the tire is oxidized inorganic additive like sulfur is generated and when the tire is incinerated the carbon black is generated and thus the air pollution is increased.

Regenerated rubber is retrievable by aging the powder of tire with high-pressure steam, removing filing materials and isolating sulfuric components by the use of solvent like oil, but its economic efficiency has depreciated because of the increasing usage of steel radial tires.

According to the pyrolysis, oil and gas are produced and used as fuel and the remainder can be reused as activated carbon or carbon black. However, this method suffers from low efficiency due to the coking during the pyrolysis process, and the resulting oil needs to be refined, making itself less competitive regarding compared to petroleum.

### SUMMARY OF THE INVENTION

The present invention is provided to avoid the problems arising from the prior art. The technical objective of the invention is to provide a coating composition using rubber compound, preferably scrap tire, and method of producing the same. The coating composition is obtained by extracting a liquid styrene butadiene rubber from a rubber compound, preferably scrap tire, containing carbon black, adding an additive for hardening the liquid SBR, and selectively adding another additives selected for the different usages of the composition.

Other configurations, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views. In the drawings:

FIG. 1 is a schematic block diagram showing the method of producing coating composition using rubber compound, preferably scrap tire.

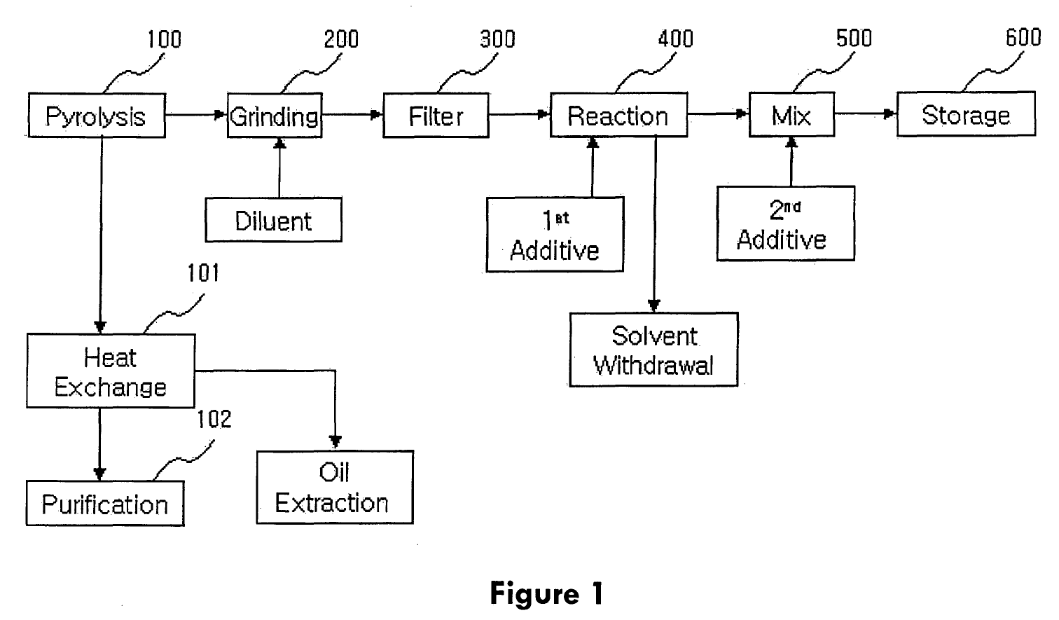

### DETAILED DESCRIPTION OF THE PREFERRED EMBODIMENTS

A preferred embodiment of the present invention is disclosed with reference to the accompanied drawings.

The method of present invention for producing a coating composition using rubber compound, preferably scrap tire, comprises the steps of: extracting a liquid styrene butadiene rubber(SBR) containing carbon black by heating a crushed rubber compound, preferably scrap tire, at the temperature of 280° C.-340° C.; grinding the liquid SBR containing carbon black by adding a 20-40 wt % diluent selected from the group consisting of alcohol, benzene, acetone, petroleum ether, ether, carbon disulfide, carbon tetrachloride, toluene and ethereal oil to the liquid SBR, filtering the composition of the grinded SBR and the diluent to remove un-grinded components; agitating the composition at the temperature of 90° C.-120° C. by adding a first additive of 5-10 wt % being composed of liquid petroleum resin, stearic acid, sulfuret, zinc oxide, mercaptobenzothiazole and diphenylguanidine, wherein the first additive decides the viscosity and/or hardness of the composition; and mixing the composition with a second additive by adding the second additive of 15-20 wt % being selected from the group consisting of epoxy, polyurethane, rubber chloride, vinyl chloride, vinyl acetate acryl, aluminum paint, chloroprene rubber and natural rubber.

The coating composition of the present invention comprises a liquid SBR containing carbon black, diluent for diluting the liquid SBR containing carbon black, a first additive for deciding the viscosity and/or hardness of the liquid SBR containing carbon black and a second additive for deciding property (use and function) of the composition.

The component ratio of the composition is as follows: a liquid SBR containing carbon black of 30-60 wt %, a diluent of 20-40 wt %, a first additive of 5-10 wt % and a second additive of 15-20 wt %. The individual component and the component ratio will be explained below in more detail.

The liquid SBR containing carbon black is extracted from the pyrolysis. The pyrolysis result of the large-sized and small-sized tires is analyzed as following table 1.

TABLE 1

| | | Large-sized | Small-sized | |
|---|---|---|---|---|
| Section | | tire (%) | tire (%) | Average |
| Benzene-extracted oil | | 12 | 19 | 15.5 |
| Carbon black | | 27 | 28 | 27.5 |
| Coal | | 8 | 6 | 7 |
| Rubber | | 53 | 47 | 50 |
| Among | Natural rubber | 72(38.16) | 42(19.74) | 57(28.5) |
| Rubber | SBR | 22(11.66) | 53(24.91) | 37.5(18.25) |
| | BR | 6(3.18) | 5(2.35) | 5.5(2.75) |

The numbers in the parentheses of table 1 are percentages against the entire tire. For example, number ‘72’ means that 72% of the rubber is natural rubber, and ‘(38.16)’ means that 38.16% of the entire tire is natural rubber.

When rubber compound, preferably scrap tire, is pyrolyzed, solid carbon black, solid coal, liquid SBR and liquid butadiene rubber are extracted by about 56%(carbon black: 27.5%, coal: 7%, liquid SBR: 18.25%, butadiene rubber: 2.75%), and gaseous rubber and gaseous benzene-extracted oil are extracted by about 44%(gaseous rubber: 28.5%, benzene-extracted oil: 15.5%). This liquid SBR containing carbon black is the base material of the coating composition of the present invention. Its quantity is between 30 and 60 wt %, and its preferable quantity will be explained below in more detail.

Considering the quantity of the gaseous rubber and gaseous benzene-extracted oil, optimal quantities of diluent and the first and second additives are calculated. That is, liquid SBR containing carbon black occupies a large proportion of the components obtained by the pyrolysis of rubber compound, preferably scrap tire, and is established as a basis of the coating composition of the present invention. The remaining components obtained by the pyrolysis, that is extracted in a gaseous form for example, correspond to the amount of the diluent, first and second additives that are required for the coating composition of the present invention.

The diluent is used for diluting the liquid SBR containing carbon black and is selected from the group consisting of alcohol, benzene, acetone, petroleum ether, ether, carbon disulfide, carbon tetrachloride, toluene and ethereal oil. Its quantity is between 20 and 40 wt % and its preferable quantity will be explained below in more detail.

The first additive is used for adjusting the viscosity and/or hardness of the liquid SBR containing carbon black and is composed of at least one, preferably all, of liquid petroleum resin, stearic acid, sulfuret, zinc oxide, mercaptobenzothiazole and diphenylguanidine. Its quantity is between 5 and 10 wt % and its preferable quantity will be explained below in more detail.

Examining the quantity of individual component forming the first additive, liquid petroleum resin is 3-6 wt %, stearic acid is 0.7-1.4 wt %, sulfuret is 0.5-1.0 wt %, zinc oxide is 0.7-1.4 wt %, mercaptobenzothiazole is 0.05-0.1 wt % and diphenylguanidine is 0.05-0.1 wt %.

Table 2 shows relative quantity of individual component. The relative quantity of individual component is shown against 100 wt % of liquid SBR containing carbon black.

TABLE 2

| Component | Additive quantity (wt %) |
|---|---|
| Liquid petroleum resin | 3-6 |
| Stearic acid | 0.6-1.4 |
| Sulfuret | 0.5-1.0 |
| Zinc oxide | 0.7-1.4 |
| Mercaptobenzothiazole | 0.05-0.1 |
| Diphenylguanidine | 0.05-0.1 |

However, the respective quantities of the individual additives are not limited to the contents of the above table 2 and can easily be changed with the specific purposes of the coating composition by the ordinary person skilled in the art.

The table 3 shows the influence of the first additive to the coating composition for the liquid SBR of 30-60 wt % containing carbon black. Namely, the hardness of the coating composition is illustrated in terms of the amount of the first additive detected from the coating layer and the detected amount of carbon black and SBR.

In the table 3, ‘O’ indicates “detected”, ‘?’ indicates “detected by infinitesimal quantity” and ‘X’ indicates “undetected”.

TABLE 3

| Section | Additive quantity (wt %)/Detected amount | | | | | | | |
|---|---|---|---|---|---|---|---|---|
| Liquid | 1 | 2 | 3 | 4 | 5 | 6 | 7 | 8 |
| petroleum | X | X | X | X | X | ? | O | O |
| resin | | | | | | | | |
| Stearic acid | 0.2 | 0.4 | 0.6 | 0.8 | 1.0 | 1.2 | 1.4 | 1.6 |
| | X | X | X | X | X | X | ? | O |
| Sulfuret | 0.2 | 0.4 | 0.5 | 0.6 | 0.7 | 0.8 | 1.0 | 1.2 |
| | X | X | X | X | X | X | ? | O |
| Zinc oxide | 0.2 | 0.4 | 0.6 | 0.8 | 1.0 | 1.2 | 1.4 | 1.6 |
| | X | X | X | X | X | X | ? | O |
| Mercapto- | 0.02 | 0.04 | 0.06 | 0.08 | 0.10 | 0.12 | 0.14 | 0.16 |
| benzothiazole | X | X | X | X | X | ? | O | O |
| Diphenyl- | 0.02 | 0.04 | 0.06 | 0.08 | 0.10 | 0.12 | 0.14 | 0.16 |
| guanidine | X | X | X | X | ? | O | O | O |
| Carbon black | O | ? | X | X | X | X | X | X |
| SBR | O | ? | X | X | X | X | X | X |

As in the table 3, the most preferable amount of individual components forming the first additive is as follows: liquid petroleum resin is 3-4 wt %, stearic acid is 0.6-0.8 wt %, sulfuret is 0.5-0.6 wt %, zinc oxide is 0.6-0.8 wt %, mercaptobenzothiazole is 0.06-0.08 wt % and diphenylguanidine is 0.06-0.08 wt %.

The second additive is used for deciding the property (use, function, etc) and is selected from the group consisting of epoxy, polyurethane, rubber chloride, vinyl acetate acryl, aluminum paint, chloroprene rubber and natural rubber. Its quantity is between 15 and 20 wt % and its preferable quantity will be explained below in more detail.

In the composition composed of liquid SBR containing carbon black, diluent, first additive and second additives, etc, the viscosity and/or hardness of the resulting composition varies according to the rate of combination as shown in the table 4.

TABLE 4

| Section | The rate of combination (wt %) | | | | | |
|---|---|---|---|---|---|---|
| SBR containing carbon black | 20 | 30 | 40 | 50 | 60 | 70 |
| Diluent | 50 | 40 | 30 | 30 | 20 | 10 |
| First additive | 10 | 10 | 10 | 5 | 5 | 5 |
| Second additive | 20 | 20 | 20 | 15 | 15 | 15 |
| Viscosity (Reference value: | 6 | 18 | 28 | 34 | 40 | 60 |
| 30) | | | | | | |
| Result | −24 | −12 | −2 | +4 | +10 | +30 |

In the Table 4, ‘+’ means the viscosity level over reference value of 30, and ‘−’ means the viscosity level under reference value of 30. If the value of viscosity is too low, the adhesive property of the coating composition depreciates. And if the value of viscosity is too high, the working efficiency depreciates.

From this view, if the mixing rate of SBR containing carbon black is less than 30 wt %, viscosity is too low, and if the mixing rate is more than 60 wt %, the viscosity is too high. Thus, 40-50 wt % of SBR containing carbon black is preferable.

Preferably, SBR containing carbon black is 30-60 wt %, diluent is 20-40 wt %, first additive is 5-10 wt % and second additive is 15-20 wt %. But, it is more preferable that SBR containing carbon black is 45 wt %, diluent is 30 wt %, first additive is 7.5 wt % and second additive is 17.5 wt %. The composition having the above composition rate is not only good for the working efficiency but also good for the adhesive property of the coating composition.

The property (use and function) of the resulting coating composition is decided by the components of the second additives. The coating composition of the present invention can be used for various purposes including, but not limited to, rust proofing, waterproofing, anti-polluting or anti-contamination, fiber grid coating, sound-absorbing, soundproofing, etc. according to the components of the second additives.

Also, the coating composition of the present invention is similar to the conventional paints in terms of drying time, weatherability, machine oil resistance, gasoline resistance, acid resistance, alkalinity resistance, water resistance, heat resistance, waterproof and flexibility, etc. Furthermore, the coating composition of the present invention can be applied to various materials including wood, iron, light metals, cement and stone, etc.

According to the present invention, liquid SBR containing carbon black is extracted through the pyrolysis of the rubber compound, preferably scrap tire. By-products and gases are produced from the pyrolysis and separately collected from the liquid SBR. A substantial portion of the gases is condensed into oil during the process. Since it is reported that dioxin could be produced from the pyrolysis at the temperature of 250-350° C., the remaining gases are exhausted into the air through a secondary burner and a gas-purifier to prevent the air-pollution. The function of the coating composition of the present invention can be decided by adding respective additives to the liquid SBR according to the desired uses including, for example, rustproof, waterproof, fiber grid coating, etc.

First embodiment:

a) Extracting Raw Material (100)

Crushed rubber compounds, preferably scrap tires, are used for producing the coating composition. Rubber compounds, preferably scrap tires could be crushed into small particles using well known technologies. According to the 1st embodiment of the present invention, the crushed rubber compound, preferably scrap tire is heated at the temperature of 280° C.-340° C. to be decomposed into gas, natural rubber in its oil state and SBR containing carbon black in its liquid state. Then liquid SBR containing carbon black is extracted as a raw material for producing the coating composition of the present invention.

During the extraction of the liquid SBR containing carbon black, the heating temperature (inner temperature of the pyrolysis furnace) must be kept within the range of 280° C.-340° C. It is very difficult to get the liquid SBR containing carbon black above the heating temperature of 340° C.

Meanwhile, the gases generated during the pyrolysis of the rubber compound, preferably scrap tires, are cooled/condensed by heat exchanger and then collected in their oil state. This is the heat exchange step (101). The remaining gases uncollected during the heat exchange step (101) are purified by a secondary burner and a purifier. This step is the purification step (102).

When the SBR containing carbon black is extracted in the raw material extraction step (100), especially oil component is collected from the gas. The heat exchanger collects oil and other components by cooling and condensing the gas, and further comprises the secondary burner and the purifier for purifying the exhausted gas. The secondary burner is used for removing destructive materials(dioxin) completely, and the filter is used for removing noxious materials such as dioxin by passing the exhausted gas under a high temperature of 800-900° C. The purifier is used for removing other noxious materials by passing the gas from the secondary burner through the water to remove water-soluble material such as acid and alkali, and then through the absorbing member having activated carbon.

b) Grinding Raw Material (200)

50 wt % diluent selected from the group consisting of alcohol, benzene, acetone, petroleum ether, ether, carbon disulfide, carbon tetrachloride, toluene or ethereal oil is added to the 20 wt % liquid SBR containing carbon black from the extracting step (100). Then the diluent-added SBR is finely grinded.

c) Filtering (300)

Then the composition of diluent-added SBR is passed through the filter filtrate un-grinded solid material. Namely, the un-grinded material is removed by agitating the composition in the filter.

d) Reacting (400)

The composition from the above filtering step (300) is supplied to the inner portion of reaction tank maintaining the inner temperature of 90° C.-120° C. Heat-carrying-oil circulating pipes are installed inside the reaction tank so that the temperature of 90° C.-120° C. is maintained.

The inner temperature of the reaction tank is maintained at the temperature of 90° C.-120° C., preferably at 110° C. so that the liquid petroleum resin can have the adhesive property of rubber and the solubility of zinc oxide.

To adjust the viscosity and/or hardness of the liquid and diluent-added SBR containing carbon black, the first additive is added by 10 wt % to the composition being supplied to the reaction tank. The individual component forming the first additive is as follows; 3-6 wt % of liquid petroleum resin; 0.7-1.4 wt % of stearic acid; 0.5-1.0 wt % of sulfuret; 0.7-1.4 wt % of zinc oxide; 0.05-0.1 wt % of mercaptobenzothiazole; and 0.05-0.1 wt % of diphenylguanidine.

Meanwhile, hydrogen is supplied to the reaction tank. The hydrogen is supplied to induce a complete combination by combining the hydrogen with non-reacted carbon, because the liquid petroleum resin is composed of C9-C12. The complete chemical combination improves the quality of the liquid petroleum resin. The composition is agitated while the first additive reacts with liquid and diluent-added SBR containing carbon black.

e) Mixing (500)

The liquid and diluent-added SBR containing carbon black having reacted with the first additive is then added with the 20 wt % secondary additive. The composition is then agitated and mixed.

That is, the component which is selected from the group consisting of epoxy, polurethane, rubber chloride, vinyl chloride, vinyl acetate acryl, aluminum paint, choloroprene rubber and natural rubber is added and mixed by 20 wt %.

This second additive is used for deciding the property, use, function and performance of resulting composition.

A coating composition comprising the 20 wt % SBR containing carbon black, the 10 wt % first additive and the 20 wt % second additive is produced through the above illustrated steps

f) Storing (600)

The coating composition from the mixing step (500) is stored.

Second embodiment

The coating composition is produced by reacting and mixing the individual components using the same method as the 1st embodiment except for adding 30 wt % SBR containing carbon black, 40 wt % diluent, 10 wt % first additive and 20 wt % second additive.

Third embodiment

The coating composition is produced by reacting and mixing the individual components using the same method as the 1st embodiment except for adding 40 wt % SBR containing carbon black, 30 wt % diluent, 10 wt % first additive and 20 wt % second additive.

Fourth embodiment

The coating composition is produced by reacting and mixing the individual components using the same method as the 1st embodiment except for adding 45 wt % SBR containing carbon black, 30 wt % diluent, 7.5 wt % first additive and 17.5 wt % second additive.

Fifth embodiment

The coating composition is produced by reacting and mixing the individual components using the same method as the 1st embodiment except for adding 50 wt % SBR containing carbon black, 30 wt % diluent, 5 wt % first additive and 15 wt % second additive.

Sixth embodiment

The coating composition is produced by reacting and mixing the individual components using the same method as the 1st embodiment except for adding 60 wt % SBR containing carbon black, 20 wt % diluent, 5 wt % first additive and 15 wt % second additive.

Seventh embodiment

The coating composition is produced by reacting and mixing the individual components using the same method as the 1st embodiment except for adding 70 wt % SBR containing carbon black, 10 wt % diluent, 5 wt % first additive and 15 wt % second additive.

The results of the 1 st to 7th embodiments are presented in below table 5.

TABLE 5

| | | | | | | | |
|---|---|---|---|---|---|---|---|
| SBR containing carbon | 20 | 30 | 40 | 45 | 50 | 60 | 70 |
| black | | | | | | | |
| Diluent | 50 | 40 | 30 | 30 | 30 | 20 | 10 |
| First additive | 10 | 10 | 10 | 7.5 | 5 | 5 | 5 |
| Second additive | 20 | 20 | 20 | 17.5 | 15 | 15 | 15 |
| Viscosity | 6 | 18 | 28 | 30 | 34 | 40 | 60 |
| (Reference value: 30) | | | | | | | |
| Results | −24 | −12 | −2 | 0 | +4 | +10 | +30 |

In the table 5, ‘+’ means the viscosity level over reference value of 30, and ‘-’ means the viscosity level under reference value of 30. If the value of viscosity is too low, the adhesive property of the coating composition depreciates. And if the value of viscosity is too high, the working efficiency depreciates.

The viscosities of the 1st and the 2nd embodiments are too low. Those of the 6th and the 7th embodiments are too high. Those of the 3rd and the 4th embodiments are preferable. Especially, the 4th embodiment is the most preferable. Preferably, SBR containing carbon black is 40-60 wt %, diluent is 20-40 wt %, first additive is 5-10 wt % and second additive is 15-20 wt %. But, it is more preferable that SBR containing carbon black is 45 wt %, diluent is 30 wt %, first additive is 7.5 wt % and second additive is 17.5 wt %. The composition having the above composition rate is not only good for the working efficiency but also good for the adhesive property of the coating composition.

Thus, on the basis of the above combination rate, the change of properties according to the different kinds of the second additive is examined.

Eighth embodiment

The coating composition is produced by reacting and mixing the individual components using the same method as the 1st embodiment except for adding 45 wt % SBR containing carbon black, 30 wt % diluent, 7.5 wt % first additive and 17.5 wt % epoxy as the second additive.

Ninth embodiment

The coating composition is produced by reacting and mixing the individual components using the same method as the 8th embodiment except for combining 17.5 wt % polyurethane as the second additive.

Tenth embodiment

The coating composition is produced by reacting and mixing the individual components using the same method as the 8th embodiment except for combining 17.5 wt % vinyl chloride as the second additive.

Eleventh embodiment

The coating composition is produced by reacting and mixing the individual components using the same method as the 8th embodiment except for combining 17.5 wt % rubber chloride as the second additive.

Twelfth embodiment

The coating composition is produced by reacting and mixing the individual components using the same method as the 8th embodiment except for combining 17.5 wt % vinyl acetate as the second additive.

Thirteenth embodiment

The coating composition is produced by reacting and mixing the individual components using the same method as the 8th embodiment except for combining 17.5 wt % aluminum paint as the second additive.

Fourteenth embodiment

The coating composition is produced by reacting and mixing the individual components using the same method as the 8th embodiment except for combining 17.5 wt % mixture of chloroprene and natural rubber as the second additive.

Fifteenth embodiment

The coating composition is produced by reacting and mixing the individual components using the same method as the 8th embodiment except for combining 17.5 wt % mixture of polyurethane and natural rubber as the second additive.

Sixteenth embodiment

The coating composition is produced by reacting and mixing the individual components using the same method as the 8th embodiment except for combining 17.5 wt % mixture of epoxy and natural rubber as the second additive.

The characteristics of the coating compositions produced from the above 8th to 16th embodiments are superior or similar to those of the conventional paint as shown in the below tables 6 and 7.

TABLE 6

| | Comparable examples (Conventional paints) | | | | | | |
|---|---|---|---|---|---|---|---|
| | 1 | 2 | 3 | | | 6 | 7 |
| | (Rubber | (Vinyl | (Vinyl | 4 | 5 | (Aluminum | (Silicon |
| | chloride) | chloride) | acetate) | (Urethane) | (Epoxy) | paint) | sealant) |
| Dry condition | Ordinary | Ordinary | Ordinary | Ordinary | Ordinary | Ordinary | Ordinary |
| | temperature | temperature | temperature | temperature | temperature | temperature | temperature |
| Dry method | Volatilization | Volatilization | Volatilization | Hardening | Hardening | Oxidation | Volatilization |
| Dry Time | 1 | 1 | 2 | 8 | 24 | 15 | 1 |
| (20° C.) | | | | | | | |
| Weatherability | * | * | * | 0 | XX | 0 | 0 |
| Machine oil resistance | 0 | 0 | 0 | 0 | 0 | 0 | X |
| Gasoline resistance | X | X | 0 | 0 | 0 | 0 | XX |
| Acid resistance | 0 | 0 | 0 | 0 | 0 | * | 0 |
| Alkalinity resistance | 0 | 0 | 0 | 0 | 0 | 0 | 0 |
| Water resistance | 0 | 0 | 0 | 0 | 0 | 0 | 0 |
| Heat resistance | X | X | X | X | X | 0 | X |
| Waterproof | 0 | 0 | 0 | 0 | 0 | 0 | 0 |
| Flexibility | 0 | 0 | 0 | 0 | * | 0 | 0 |

TABLE 7

| | Embodiments | | | | | | | | |
|---|---|---|---|---|---|---|---|---|---|
| | 8th | 9th | 10th | 11th | 12th | 13th | 14th | 15th | 16th |
| Dry condition | Ordinary | Ordinary | Ordinary | Ordinary | Ordinary | Ordinary | Ordinary | Ordinary | Ordinary |
| | temper- | temper- | temperature | temperature | temperature | temperature | temperature | temperature | temperature |
| | ature | ature | | | | | | | |
| Dry method | Hardening | Hardening | Volatilization | Volatilization | Volatilization | Oxidation | Volatilization | Hardening | Hardening |
| Dry time | 18 | 6 | 1 | 1 | 1 | 10 | 1 | 18 | 6 |
| (20° C.) | | | | | | | | | |
| Weatherability | X | 0 | 0 | 0 | 0 | 0 | 0 | * | * |
| Machine oil | 0 | 0 | 0 | 0 | 0 | * | 0 | 0 | 0 |
| resistance | | | | | | | | | |
| Gasoline | 0 | 0 | 0 | X | X | 0 | 0 | * | * |
| resistance | | | | | | | | | |
| Acid resistance | 0 | 0 | 0 | 0 | 0 | 0 | 0 | 0 | 0 |
| Alkalinity | 0 | 0 | 0 | 0 | 0 | 0 | 0 | 0 | 0 |
| resistance | | | | | | | | | |
| Water | 0 | 0 | 0 | 0 | 0 | 0 | 0 | 0 | 0 |
| resistance | | | | | | | | | |
| Heat resistance | X | X | X | X | X | 0 | X | X | X |
| Waterproof | 0 | 0 | 0 | 0 | 0 | 0 | 0 | 0 | 0 |
| Flexibility | 0 | 0 | 0 | 0 | 0 | 0 | 0 | 0 | 0 |

In the tables 6 and 7, ‘0’ means that the degree of the characteristic is above 80%, ‘*’ means that the degree of the characteristic is 60-80%, ‘X’ means that the degree of the characteristic is 30-60% and ‘XX’ means that the degree of the characteristic is 10-30%. That is, the performance increases according to the rise of the percentage.

As shown in the tables 6 and 7, the performance of the present invention is superior or equal to the conventional paint.

Meanwhile, as shown in the below table 8, the application range of the coating composition from the 8th to 16th embodiments is as various as that of conventional paint.

TABLE 8

| | Section | | | | |
|---|---|---|---|---|---|
| | | | Light | | |
| | Wood | Iron | metal | Cement | Stone |
| Comparable example 1 | 0 | * | XX | 0 | 0 |
| Comparable example 2 | 0 | 0 | X | 0 | 0 |
| Comparable example 3 | 0 | 0 | 0 | * | 0 |
| Comparable example 4 | 0 | 0 | * | 0 | 0 |
| Comparable example 5 | * | 0 | * | 0 | 0 |
| Comparable example 6 | * | 0 | 0 | * | * |
| Comparable example 7 | 0 | * | * | 0 | 0 |
| Embodiment 8 | 0 | 0 | 0 | 0 | 0 |
| Embodiment 9 | 0 | * | * | 0 | 0 |
| Embodiment 10 | 0 | * | X | 0 | 0 |
| Embodiment 11 | 0 | * | X | 0 | 0 |
| Embodiment 12 | 0 | 0 | * | 0 | 0 |
| Embodiment 13 | * | 0 | 0 | * | * |
| Embodiment 14 | 0 | 0 | 0 | 0 | 0 |
| Embodiment 15 | 0 | 0 | * | 0 | 0 |
| Embodiment 16 | 0 | 0 | * | 0 | 0 |

In the above table 8, ‘O’ means “highly applicable”, ‘*’ means “applicable”, ‘X’ means “less applicable” and ‘XX’ means “hardly applicable”.

As shown in the table 8, the coating composition of the present invention is applicable to various materials, including, but not limited to, wood, iron, light metal, cement, stone, etc.

The coating composition of the present invention can be obtained by extracting a liquid styrene butadiene rubber (SBR) from a rubber compound, preferably scrap tire, containing carbon black, adding an additive for hardening the liquid SBR, and selectively adding another additives selected for the different usages of the composition. According to the present invention, a novel coating composition that can be used for rust proofing, waterproofing, fiber grid coating etc. is provided. Also, a large volume of rubber compounds, preferably scrap tires, which otherwise may cause environmental pollution, can be recycled in an economic and reliable process.

The present invention can be embodied in other specific forms without departing from the spirit or essential attributes thereof. For example, liquid styrene butadiene rubber can be obtained from many known rubber compounds with or without carbon black. When styrene butadiene rubber without carbon black is used for the present invention, some of the producing steps such as grinding are not necessary. Accordingly, reference should be made to the following claims, rather than to the foregoing specification, as indicating the scope of the present invention.

What is claimed is:

1. Coating composition using rubber compound, preferably scrap tire, comprising:
30-60 wt % liquid styrene butadiene rubber containing carbon black; 20-40 wt % diluent for diluting the liquid styrene butadiene rubber containing carbon black, wherein the diluent being selected from the group consisting of alcohol, benzene, acetone, petroleum ether, ether, carbon disulfide, carbon tetrachloride, toluene and ethereal oil; 5-10 wt % first additive for hardening the liquid styrene butadiene rubber containing carbon black, wherein the first additive being composed of liquid petroleum resin, stearic acid, sulfuret, zinc oxide, mercaptobenzothiazole and diphenylguanidine; and 15-20 wt % second additive for deciding the property of the liquid styrene butadiene rubber containing carbon black, wherein the second additive being selected from the group consisting of epoxy, polyurethane, rubber chloride, vinyl acetate acryl, aluminum paint, chloroprene rubber and natural rubber.

2. The coating composition of claim 1, wherein the first additive comprising:
3-6 wt % liquid petroleum resin;
0.7-1.4 wt % stearic acid;
0.5-1.0 wt % sulfuret;
0.7-1.4 wt % zinc oxide;
0.05-0.1 wt % mercaptobenzothiazole; and
0.05-0.1 wt % diphenylguanidine.

3. Coating composition comprising:
30-60 wt % liquid styrene butadiene rubber;
20-40 wt % diluent selected from the group consisting of alcohol, benzene, acetone, petroleum ether, ether, carbon disulfide, carbon tetrachloride, toluene and ethereal oil;
5-10 wt % first additive comprising at least one of liquid petroleum resin, stearic acid, sulfuret, zinc oxide, mercaptobenzothiazole and diphenylguanidine; and
15-20 wt % second additive selected from the group consisting of epoxy, polyurethane, rubber chloride, vinyl acetate acryl, aluminum paint, chloroprene rubber and natural rubber.

4. Coating composition of claim 3, wherein the liquid styrene butadiene rubber contains carbon black.

5. Coating composition of claim 3 or 4, wherein the first additive comprises:
3-6 wt % liquid petroleum resin;
0.7-1.4 wt % stearic acid;
0.5-1.0 wt % sulfuret;
0.7-1.4 wt % zinc oxide;
0.05-0.1 wt % mercaptobenzothiazole; and
0.05-0.1 wt % diphenylguanidine.

6. Waterproofing material comprising any one of the coating compositions of claims 1 to 5.

7. Rust-proofing material comprising any one of the coating compositions of claims 1 to 5.

8. Anti-contamination material comprising any one of the coating compositions of claims 1 to 5.

9. Sound-absorbing material comprising any one of the coating compositions of claims 1 to 5.

10. Soundproofing material comprising any one of the coating compositions of claims 1 to 5.

11. Fiber grid coating material comprising any one of the coating compositions of claims 1 to 5.

12. Method for producing a coating composition using rubber compound, preferably scrap tire, comprising:
a) extracting a liquid styrene butadiene rubber containing carbon black by heating a crushed rubber compound, preferably scrap tire, at the temperature of 280° C.-340° C.;
b) grinding the liquid styrene butadiene rubber containing carbon black by adding a 20-40 wt % diluent selected from the group consisting of alcohol, benzene, acetone, petroleum ether, ether, carbon disulfide, carbon tetrachloride, toluene and ethereal oil to the liquid styrene butadiene rubber;
c) filtering the liquid styrene butadiene rubber containing carbon black to remove un-grinded components;
d) agitating the liquid styrene butadiene rubber containing carbon black at the temperature of 90° C.-120° C. by adding a 5-10 wt % first additive being composed of liquid petroleum resin, stearic acid, sulfuret, zinc oxide, mercaptobenzothiazole and diphenylguanidine to decide the viscosity and/or hardness of the coating composition; and
e) mixing the liquid styrene butadiene rubber containing carbon black with a second additive by adding the 15-20 wt % second additive being selected from the group consisting of epoxy, polyurethane, rubber chloride, vinyl chloride, vinyl acetate acryl, aluminum paint, chloroprene rubber and natural rubber.

13. The method for producing a coating composition of claim 12, wherein the extracting step a) further comprising:
f) collecting natural rubber in its oil state;
g) collecting oil and diluent components by cooling and condensing the exhausted gas; and
h) purifying the exhausted gas through a burner and a purifier.

14. Method for producing a coating composition comprising:
a) extracting a liquid styrene butadiene rubber by heating a rubber compound at the temperature of 280° C.-340° C.;
b) adding a first additive comprising at least one of liquid petroleum resin, stearic acid, sulfuret, zinc oxide, mercaptobenzothiazole and diphenylguanidine; and
c) adding a second additive being selected from the group consisting of epoxy, polyurethane, rubber chloride, vinyl chloride, vinyl acetate acryl, aluminum paint, chloroprene rubber and natural rubber.

15. Method for producing the coating composition of claim 14, further comprising:
c) grinding the liquid styrene butadiene rubber by adding a 20-40 wt % diluent selected from the group consisting of alcohol, benzene, acetone, petroleum ether, ether, carbon disulfide, carbon tetrachloride, toluene and ethereal oil to the liquid styrene butadiene rubber;
d) filtering the liquid styrene butadiene rubber to remove un-grinded components;

16. Method for producing the coating composition of claim 14 or 15, wherein the liquid styrene butadiene rubber contains carbon black.

17. Method for producing any one of the coating compositions of claims 14 to 16, wherein the first additive comprises:
3-6 wt % liquid petroleum resin;
0.7-1.4 wt % stearic acid;
0.5-1.0 wt % sulfuret;
0.7-1.4 wt % zinc oxide;
0.05-0.1 wt % mercaptobenzothiazole; and
0.05-0.1 wt % diphenylguanidine.

18. Method for producing the coating composition of claim 14 or 15, comprising:
e) agitating the liquid styrene butadiene rubber containing carbon black at the temperature of 90° C.-120° C. by adding the 5-10 wt % first additive being composed of liquid petroleum resin, stearic acid, sulfuret, zinc oxide, mercaptobenzothiazole and diphenylguanidine to decide the viscosity and/or hardness of the coating composition; and
f) mixing the liquid styrene butadiene rubber containing carbon black with the second additive by adding the 15-20 wt % second additive being selected from the group consisting of epoxy, polyurethane, rubber chloride, vinyl chloride, vinyl acetate acryl, aluminum paint, chloroprene rubber and natural rubber.

19. Method for producing one of the coating compositions of claims 14 to 18, further comprising:
g) collecting natural rubber in its oil state;
h) collecting oil and diluent components by cooling and condensing the exhausted gas; and
i) purifying the exhausted gas through a burner and a purifier.

20. Method for producing one of the coating compositions of claims 14 to 18, wherein the rubber compound comprises tire.
